(19) United States
(12) Patent Application Publication
(10) Pub. No.: US 2010/0266177 A1
(43) Pub. Date: Oct. 21, 2010

(54) SIGNAL PROCESSING BY ITERATIVE DECONVOLUTION OF TIME SERIES DATA

(75) Inventors: Xiao-Ping Zhang, Ontario (CA); Daniel B. Allison, Indianapolis, IN (US)

Correspondence Address: KILYK & BOWERSOX, P.L.L.C., 3925 CHAIN BRIDGE ROAD, SUITE D401, FAIRFAX, VA, 22030, US

(73) Assignee: APPLIED BIOSYSTEMS, LLC, Carlsbad, CA (US)

(21) Appl. No.: 12/634,133

(22) Filed: Dec. 9, 2009

Related U.S. Application Data
(63) Continuation of application No. 10/430,152, filed on May 6, 2003, now abandoned.
(60) Provisional application No. 60/378,427, filed on May 7, 2002.

(51) Int. Cl. G06K 9/00

(52) U.S. Cl. 382/129

(57) ABSTRACT

A signal processing method is provided and involves iteratively deconvoluting at least one digital signal data set with respect to time. A signal processor is also provided that can perform a signal processing method for iteratively deconvoluting at least one digital signal data set. Also provided is an instruction set readable by a machine, tangibly embodying a program of instructions executable by a machine to perform a signal processing method of iteratively deconvoluting at least one digital signal data set. Also provided is a data set readable by a machine, tangibly embodying a data set computed by a signal processing method for iteratively deconvoluting at least one digital signal data set.

### CROSS-REFERENCE TO RELATED APPLICATION

The present application in a continuation of U.S. patent application Ser. No. 10/430,152, filed May 6, 2003, which claims a priority benefit under 35 U.S.C. §119(e) from U.S. Patent Application No. 60/378,427, filed May 7, 2002, both of which are incorporated herein in their entireties by reference.

### FIELD

This application relates to a signal processing method that involves deconvoluting a data set. The present application also relates to a signal processor for deconvoluting a data set. The present invention also relates to an instruction set readable by a machine, tangibly embodying a program of instructions executable by a machine to perform a signal processing method that involves deconvoluting a data set.

### BACKGROUND

Automated DNA sequencing presents a number of challenges to a data analyzing process. Input data can be highly variable and predictive models of data behaviour are lacking, yet computer analysis routines are expected to produce highly accurate output data. Basecalling is the data analysis part of automated DNA sequencing. Basecalling takes the time-varying signal of four fluorescence intensities and produces an estimate for an underlying DNA sequence that gave rise to that signal. A need exists for a data analysis method that addresses the problems associated with conventional basecalling techniques.

### SUMMARY

According to various embodiments, a method is provided whereby individual peak signals can be distinguished from a group of signals by isolating and visualizing the individual peak signals from an overall digital signal data set, for example, from an overall digital data set in the form of a graph with peaks. Herein, a digital signal data set refers to any data set that represents a convoluted signal, for example: a digital signal array representing a detection of an analyte in a detection zone over a period of time; a convoluted signal including a signal strength component and a time component; a convoluted signal including a signal strength component and a distance component; a convoluted signal having three components, such as a signal strength component, a time component, and a distance component; an analog signal that can be or has been converted to digital form; or a combination thereof.

Various embodiments can provide a signal processing method for iteratively deconvoluting a digital signal data set representing one or more sets of data corresponding to one or more nucleic acids contained in a sample.

According to various embodiments, data obtained from, for example, a capillary electrophoresis method, a gel electrophoresis method, or another analytical separation method, can be processed. The data can result from a separation of respective polynucleotides from a sample that includes a plurality of polynucleotides.

During electrophoretic separation, smaller, lighter polynucleotides generally move faster through separation media than do larger, heavier polynucleotides. Because the larger, heavier polynucleotides generally move more slowly, they are detected at a latter point in time than faster polynucleotides travelling the same or a similar path through an electrophoretic separation medium. When the path of travel traverses a detection zone, for example, the location of a laser digitizing device and a corresponding detector, the faster polynucleotides are detected sooner than the slower moving polynucleotides. Herein, a laser digitizer can include, for example, a system having a laser source, a laser-illuminated detection zone, and a digital detector such as a charge-coupled device, or other flourescence or emission detection devices. According to various embodiments, other light source and light detection systems can be used in place of the laser digitizer mentioned above. According to various embodiments, the signal width of the digital signal data set resulting from the detection can vary with time during separation. This process, in part, is called convolution. In order to accurately identify individual nucleic acids of the polynucleotide, various embodiments can provide methods for deconvoluting such a digital signal data set.

According to various embodiments, signal processing methods are provided that include providing at least one digital signal data set having at least one amplitude representing a sample containing at least one nucleic acid. The method can include adaptively estimating a point spread function for the digital signal data set. The method can include adaptively iteratively deconvoluting the digital signal data set based on the estimated point spread function, to form a deconvoluted digital signal data set having at least one deconvoluted amplitude representing the presence of the at least one nucleic acid.

According to various embodiments, signal processing methods are provided that can include providing at least one digital signal data set having at least one amplitude representing a sample containing at least one nucleic acid. The method can include normalizing the at least one amplitude to form at least one first normalized digital signal data set. The method can include adaptively estimating a point spread function for the at least one first digital signal data set. The method can include adaptively iteratively deconvoluting the first normalized digital signal data set based on the estimated point spread function, to form a deconvoluted digital signal data set having at least one deconvoluted amplitude representing the presence of the at least one nucleic acid.

Further information on basecalling can be found at, for example, T. A. Brown, DNA Sequencing: The Basics, Oxford University Press, New York, 1994; and R. W. Schafer, R. M. Mersereau and M. A. Richards, “Constrained Iterative Restoration Algorithms,” Proceedings of the IEEE, vol. 69, no. 4, April 1981. The above-mentioned references are herein incorporated by reference in their entireties.

A description of various methods describing mathematics useful in basecalling can be found, for example, in U.S. Pat. No. 5,748,491 to Allison et al. and U.S. Pat. No. 6,236,945 B1 to Simpson et al. The above-mentioned references are herein incorporated by reference in their entireties.

The application can be more fully understood with reference to the accompanying drawing figures and the brief description thereof. Modifications that would be evident to those skilled in the art are considered a part of the present application and within the scope of any claims that might be included in any patent applications covering various embodiments.

### BRIEF DESCRIPTION OF THE DRAWINGS

FIG. 1 is a flow-chart of a method for iteratively deconvoluting a digital signal data set;

FIG. 2 is a schematic diagram of an electrophoresis and fluorescence detection system;

FIG. 3 is a schematic diagram of a computer system 500 with which various embodiments can be implemented and used;

FIG. 4 depicts a digital signal data set (at the top of the figure) prior to iterative deconvolution by the signal processing method according to various embodiments, and a deconvolved digital signal data set (at the bottom of the figure) following deconvolution by the signal processing method according to various embodiments near the end of the digital signal data set data;

FIG. 5a depicts a digital signal data set (a line with x's thereon) prior to iterative deconvolution;

FIG. 5b depicts a deconvolved signal data set (a line with x's thereon) iteratively deconvoluted by an algorithm according to various embodiments; and

FIG. 6 is a graph of signal strength plotted against time showing both the digital signal data set (a line with dots (.) thereon) and the deconvoluted digital signal data set (a line with x's thereon).

Other various embodiments will be apparent to those skilled in the art from consideration of the specification and practice disclosed herein, and the detailed description that follows. It is intended that the specification and examples be considered as exemplary only, with the true scope and spirit of the teachings including other various embodiments.

### DETAILED DESCRIPTION

In deoxyribonucleic acid (DNA) sequencing, there are four possible chemical base types that contain genetic information: adenine (A), cytosine (C), guanine (G), thymine (T). The four base types are identified by examining four DNA electrophoresis time series data in the form of, for example, a digital signal data set. This procedure is called “basecalling.” According to various embodiments, a systematic signal processing method is provided that can enhance the signal quality of the digital signal data set based on an iterative deconvolution method. According to various embodiments, sharper peaks for a digital signal data set, relative to raw data, can be recovered and subsequent basecalling performance can be improved.

In chemical processing of DNA base sequences, electrophoresis can be used to discriminate between different molecules by length, that can be translated or interpreted to determine the position of each base of the sequence. Each base in the sequence, in the obtained DNA electrophoresis time series data, is represented by high-level signals (peaks) with certain shapes. By looking for the positions of these signal “peaks” in the digital signal data set, the DNA base sequence can be identified. This procedure is called “basecalling.” Ideally, at any base position, there should be a corresponding singular peak in the corresponding digital signal data set. However, in practice, there are many other undesired signals and signal features that can prevent accurate peak detection from the digital signal data set. A prominent factor can be the degradation of signal resolution, i.e., the signal peak is not an ideal sharp peak but is a waveform with a certain spread width. When there are multiple consecutive peaks, signal resolution can lead to difficulty in correctly detecting the accurate signal peaks. This problem can become severe close to the end of the digital signal data set because the signal resolution can become very poor.

According to various embodiments, a digital signal data set can include at least four signals from the four DNA nucleotides or from the four RNA nucleotides. The digital signal data set can, alternately or additionally, include a signal from a ladder or standard. The ladder or standard can be, for example, a labeled polynucleotide or series of labeled polynucleotides, of known lengths.

According to various embodiments, a digital data set can have a plurality of signals representing a sample containing at least deoxyadenylate, deoxyguanylate, deoxycytidylate, and deoxythymidylate. The digital signal data set can alternatively or additionally include a signal representing a polynucleotide ladder or standard.

According to various embodiments, a signal processing method adapted to enhance the signal quality of a digital signal data set is provided. The method can recover sharp peaks in a digital signal data set, can improve basecalling accuracy, can improve read length, or combinations thereof. According to various embodiments, the method is related to an iterative nonlinear deconvolution algorithm. Unlike the commonly used linear Wiener filtering method, that can often suffer ringing effects, various embodiments can recover the sharp base peaks without adding any secondary false peaks caused by ringing.

According to various embodiments, the electrophoresis signal generation for the DNA sequencing can ideally be treated as a linear system.

According to various embodiments, the deconvolution problem in DNA electrophesing time series can be formulated.

According to various embodiments, the observed DNA electrophoresis digital signal y(n) can be assumed to be the convolution of the input signal x(n) and point spread function h(n)

y(n)=x(n) [symbol] h(n). (Eq. 1)

In electrophoresis, x(n) can be a sparse pulse train which represents the base locations and signal strength amplitude, i.e.,

$$x ( n ) = {\sum }_{k} a ( k ) p ( n - k ) , \qquad ( Eq . 2 )$$

where the p(n) can be a very narrow pulse, for example, p(n)=δ(n), where δ(n) is called the Kronecker function, a(k)≠0, and k represents the base positions. According to various embodiments, a basecalling algorithm can be utilized to find an estimate of x(n), denoted by \hat{x}(n), given the observed electrophoresis series y(n).

According to various embodiments, an iterative algorithm can be generally described as follows. Starting from an initial signal vector x₀ and using the following iteration,

xₖ₊₁=Fxₖ, (Eq. 3)

where “F” is an operator and xₖ denotes the signal vector value at the k-th iteration, an operator can be defined such that when k is sufficiently large, xₖ converges to the underlying pulse train represented by Eq. 2, denoted by vector x, i.e.,

$${lim}_{k -> ∞} {x}_{k} = x . \qquad ( Eq . 4 )$$

In the iterative algorithm as in Eq. 3, “F” can be a contract mapping with x being the fixed point of the mapping, i.e.,

∥Fxᵢ−Fxⱼ∥≦r∥xᵢ−xⱼ∥, 0≦r<1 (Eq. 5)

and

x=Fx, (Eq. 6)

the iterative algorithm can converge to x, i.e.,

$${{x}_{k}}_{k -> ∞} = x .$$

A basic iteration equation can be:

xₖ₊₁=Fxₖ=λy+Gxₖ, (Eq. 7)

where operator G can be constructed such that F can be a contract mapping, and λ is a learning parameter which is related to the convergence of the iteration and can be used to control the rate of convergence of the iteration.

According to various embodiments of the present invention, some properties of the DNA electrophoresis time series can include, for example:
Positivity—According to various embodiments, the underlying pulse train that represents the bases can always be positive, i.e., a(k)≧0 in Eq. 2;
Time localization—According to various embodiments, each pulse p(n) that represents one base can have limited time duration (i.e., pulse p(n) must be very narrow), where the duration of one pulse can be denoted as d and/or d=1 when p(n)=δ(n); or
combinations thereof.

According to various embodiments, by incorporating, for example, the above-mentioned signal properties of the DNA electrophoresis, a contracted mapping operator G can be developed for the DNA electrophoresis signal vector x, with an individual element denoted by x(n). A mapping F can be then constructed:

xₖ₊₁=Fxₖ=Gxₖ+λ(y−h [symbol] Gxₖ). (Eq. 8)

The vector x can be a fixed point of F, if x is a fixed point of mapping operator G. If the point spread function h satisfies a certain property, the mapping F can be a contract mapping. The parameter λ is a learning parameter which is related to the convergence of the iteration and can be used to control the rate of convergence of the iteration.

According to various embodiments, the operators as defined can be nonlinear. Therefore, the constructed iterative algorithm can be a non-linear method and not a linear filtering method.

According to various embodiments, the following steps can be used to obtain the deconvoluted DNA electrophoresis signals. The method can include all of the following steps, some of the following steps, or none of the following steps. The method can include some or all of the steps in the below-described order, or in another order. Various embodiments can include portions of any of the respective below-described steps.

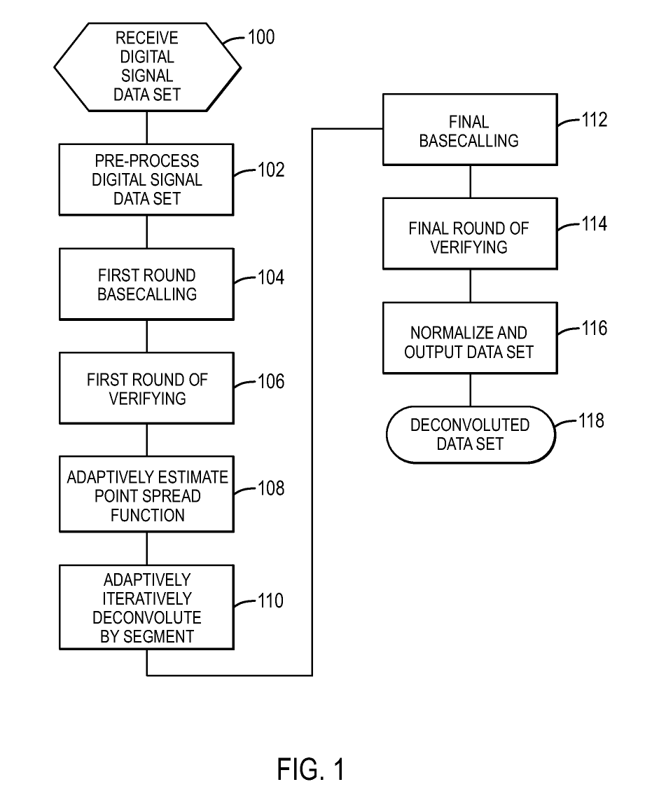

FIG. 1 depicts an iterative deconvolution method according to various embodiments. At step 100 a digital signal data set to be deconvoluted can be received. At step 102 a multitude of signal pre-processing steps can be performed. At step 104, a first round of basecalling on the pre-processed signal data set can be performed. Data from step 104 can be verified during a first round of verifying at step 106. Various algorithms implemented as a first computer program in hardware or software can be used to adaptively estimate a local point spread function across various combinations of local peaks during step 108. The adaptively estimated local point spread function of step 108 can be used to segment the digital signal data set. The adaptively estimated local point spread function of step 108 can adaptively deconvolute the digital signal data set during step 110. Various algorithms implemented as a second computer program in hardware or software can be used to adaptively deconvolute a digital signal data set for step 110. Data output from step 110 can be used for a final round of basecalling in step 112. A digital signal data set can go through a final round of verification at step 114 and a final round of normalization at step 116. Step 118 depicts the output of the deconvoluted data set.

According to various embodiments, the step of preprocessing the digital signal data sets can include at least one of the following. The at least four dye electrophoresis signals can be filtered and multi-componented and the baseline can be removed. The mobility shift can be compensated for. The peak spacing can be normalized along a time dimension in order to produce a regularized signal where the peaks are enhanced and made uniform.

According to various embodiments, the step of estimating an adaptive point spread function can include at least one of the following. Peaks can be detected in a regularized trace and can be basecalled with standard classification methods known in the art. The called peaks can be used to adaptively estimate the local point spread function h. The time-localization parameter d can be estimated according to a peak spacing in a segment.

According to various embodiments, the step of adaptive deconvolution can include at least one of the following. The iterative deconvolution algorithm according to various embodiments can be applied adaptively according to an estimated local point spread function. Various embodiments can include, for example, the use of Equations 1-8 listed herein, more specifically, Equations 3-8, listed herein, or combinations thereof.

The deconvolved signal array can be output and can be used for final basecalling.

According to various embodiments, the estimated local point spread function can be compared to other estimated local point spread functions within a local area. The digital signal data set can be segmented with respect to time, based on the variation of other, surrounding estimated local point spread functions. More than one peak can be contained within one segment. Within a respective segment, the estimated local point spread functions can then be weight-averaged to obtain an estimated weight-averaged point spread function within the segment. The desired peak rate variable d can be estimated based on the peak spacing within the segment.

According to various embodiments, the point spread function can be adaptively estimated against any arbitrary shape based-point spread function. Various embodiments of the adaptively estimated point spread function can use a Gaussian shape-based point spread function. The relevant width parameter of the Gaussian function can be estimated as the weight-average of the relevant width parameters of all local point spread functions. The local point spread functions can also be Gaussian functions. The weight given the relevant width parameters of respective local point spread functions can be related to the position of the qualified peaks in the respective segments and the difference between the qualified peak shape and the ideal peak shape.

According to various embodiments, an iterative deconvolution method, as described herein can be applied to a segment of a digital signal data set. The number of iterations can be a fixed, preset value, or a mean square error (MSE) criterion, between adjacent iterations. In either case, the number of iterations can be satisfied to end the iterative deconvolution.

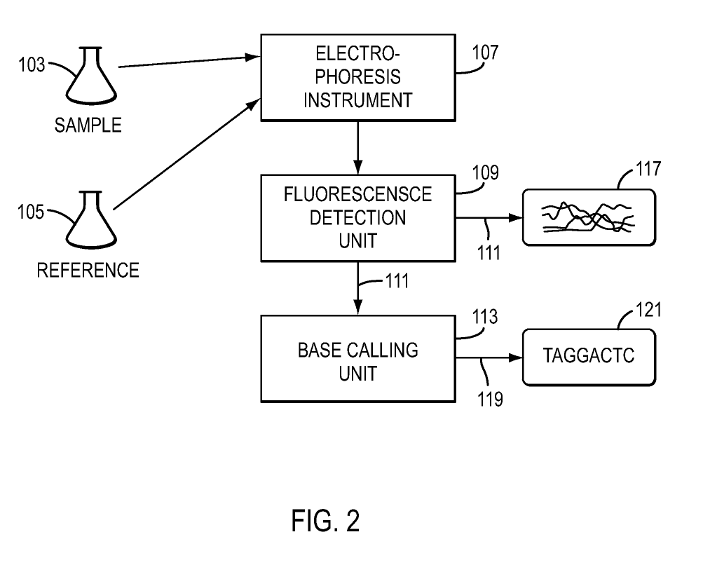

According to various embodiments, methods as described herein can be used with a basecalling unit 113 of an electrophoresis instrument 107 and a fluorescence detection unit 109, to determine a sequence 121 of a sample 103. The determination can be made using a plurality of digital signal data sets 111, as shown in FIG. 2. A reference 105 can also be processed to produce at least one additional digital data set, according to various embodiments. Digital data sets 111 can be viewed as a graph 117 and/or be provided to the basecalling unit 113.

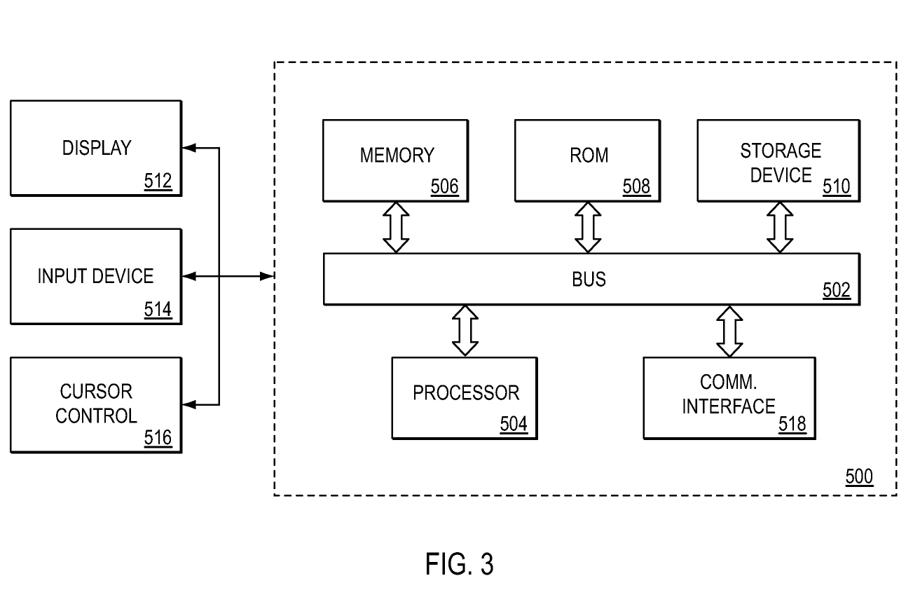

Various embodiments can be temporarily, permanently, or transiently incorporated into an electronic device 500 comprising, for example, a memory device 506, a ROM (Read-Only Memory) device 508, a storage device 510, a processor 504, a communication interface 518, a bus 502, or a combination thereof, for example, as shown in FIG. 3. The electronic device 500 can interface with various input and output devices, for example, display 512, input device 514, cursor control 516, or combinations thereof, using bus 500. Methods of the present application can be disposed in electronic device 500 in ROM 508, storage device 510, memory 506, or can be received as a signal from another electronic system using communications interface 518 and/or input device 516.

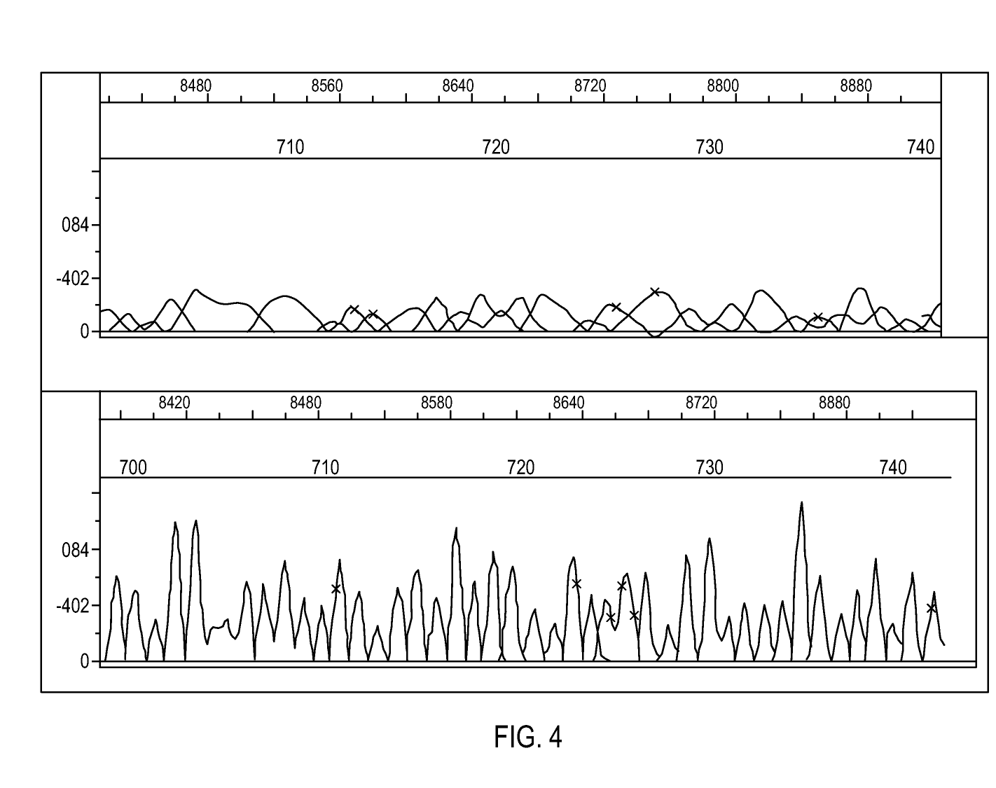

A graph of signal strength plotted against time showing both a digital signal data set (a line with dots thereon) and the deconvoluted data set (a line with x's thereon) is shown in FIG. 4.

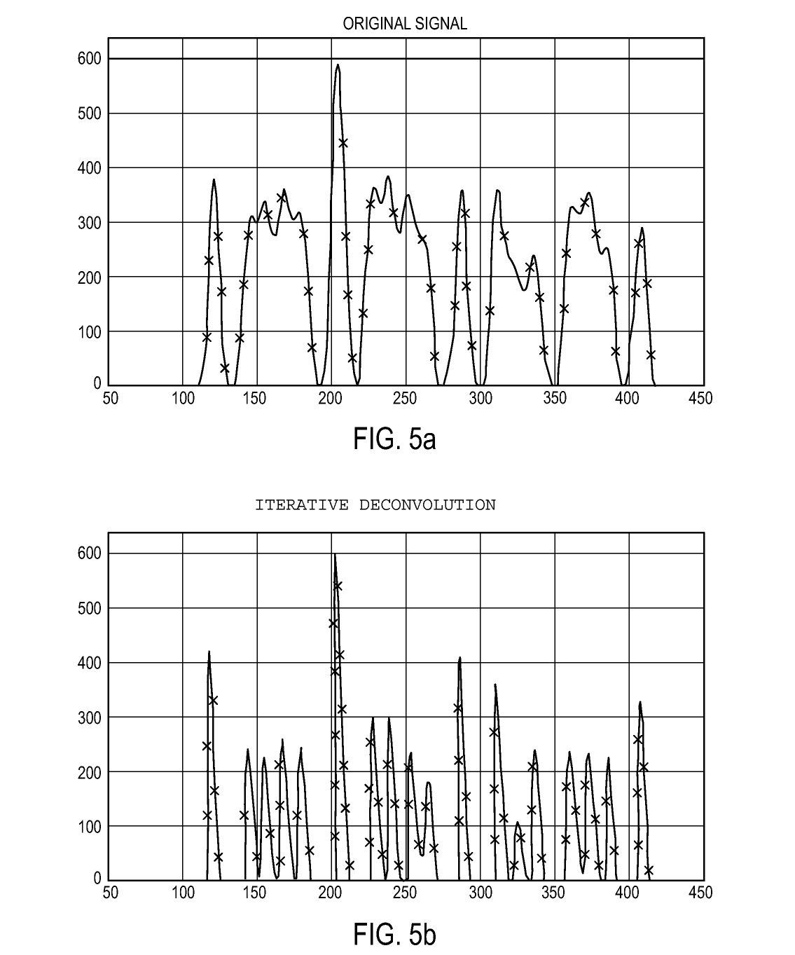

FIG. 5a depicts a digital data set (a line with x's thereon) prior to iterative deconvolution, that after iterative deconvolution, results in the deconvoluted digital data set shown in FIG. 5b.

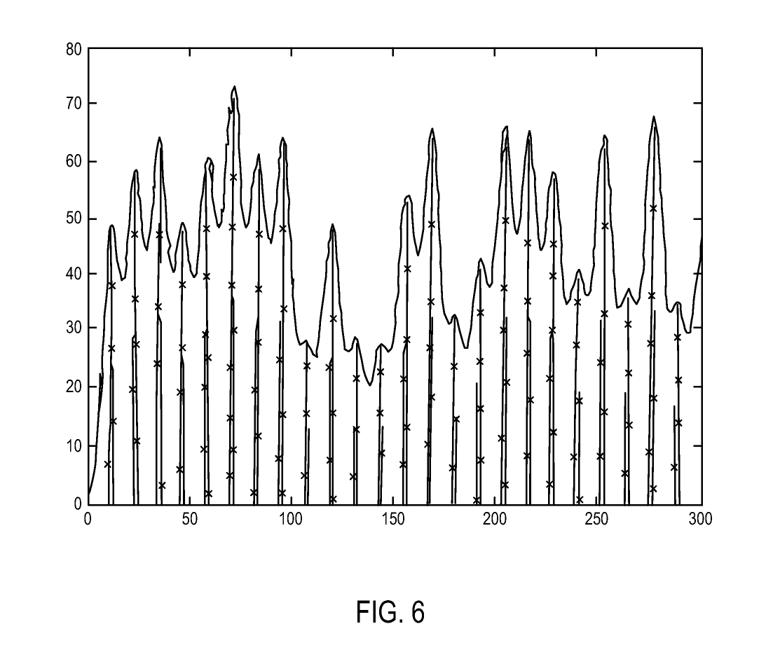

FIG. 6 shows a graphical data set and a basecalled data set using both unprocessed digital signal data (at the top of the figure) and the digital signal data processed according to various embodiments (at the bottom of the figure). The improvement of the signal quality is evident in these examples. The improvement can be reflected as sharper peaks, a resolution of a peak or segment into multiple peaks, or a combination of sharper peaks and improved resolution.

According to various embodiments, a systematic signal processing method has been developed that can enhance the quality of raw DNA sequencing electrophoresis signals. The signal enhanced by the method can be used to improve the performance of the basecalling of a DNA sequence and/or other sequence analysis applications. According to various embodiments, an algorithm of this method can include a non-linear iterative deconvolution algorithm incorporating specific characteristics that can recover sharp peaks corresponding to base positions in a digital signal data set without introducing extra, small peaks or “ringing.” According to various embodiments, applying the deconvolution algorithm to a digital signal data set can reduce the total basecalling error rate by at least 1%, for example, by about 2% or more. According to various embodiments, basecalling accuracy can be improved by greater than about 5%, for example, a reduction of the total basecalling error rate of from about 5% to about 10%. Significant basecalling accuracy improvements can result in low resolution signal areas. The digital signal data set can include signals from a sample comprising mitochondrial DNA or nuclear DNA. Modifications to the basecaller function can take full advantage of the narrow deconvoluted peaks and can further reduce the basecalling error rate and significantly improve the overall accuracy and read length.

According to various embodiments, methods are provided wherein the deconvoluted digital signal data set is represented as a graph of signal strength on a first axis, plotted against time on a second axis, and at least one graphical peak formed by the deconvoluted digital signal data set has a portion having an average width that is thinner along the time axis than the same graphical peak would have if plotted before being adaptively iteratively deconvoluted.

According to various embodiments, methods are provided wherein the preprocessing of the at least one digital data set includes preprocessing the at least one digital signal data set prior to the step of adaptively estimating a point spread function.

According to various embodiments, methods are provided that include performing a round of basecalling of the at least one digital signal data set prior to adaptively estimating a point spread function for the at least one digital signal data set, to form at least one respective first basecalled data set. The methods can include verifying the accuracy of the at least one deconvoluted digital signal data set by comparing the at least one first basecalled data set to the deconvoluted digital signal data set or a second basecalled data set basecalled from the deconvoluted digital data set.

According to various embodiments, methods are provided that include performing a round of basecalling of the at least one deconvoluted digital signal data set, to form at least one respective deconvoluted basecalled data set. The methods can include verifying the accuracy of the at least one deconvoluted digital signal data set by comparing the at least one respective basecalled data set to the deconvoluted digital signal data set.

According to various embodiments, processing methods are provided that include normalizing one or more amplitudes of the at least one deconvoluted digital signal data set.

According to various embodiments, methods are provided wherein the adaptively estimating a point spread function for the at least one digital signal data set includes isolating portions of the at least one digital signal data set that represent the presence of nucleic acids in a sample. The methods can include estimating a local point spread function for at least one isolated portion of the at least one digital signal data set. The methods can include segmenting the at least one digital signal data set with respect to time based on correlation of the estimated local point spread function of the at least one isolated portion with at least a second estimated local point spread function of at least a second isolated portion.

According to various embodiments, signal processing methods are provided wherein the at least one digital signal data set includes a plurality of digital signal data sets.

According to various embodiments, methods are provided wherein the at least one digital signal data set can include a plurality of digital signal data sets, and the adaptively estimating includes adaptively estimating a plurality of respective point spread functions for the plurality of respective digital signal data sets. The adaptively iteratively deconvoluting can comprise adaptively iteratively deconvoluting the plurality of respective digital signal data sets based on the respective estimated point spread functions, to form a respective plurality of deconvoluted digital signal data sets each having at least one deconvoluted amplitude representing the presence of the at least one labeled nucleic acid.

According to various embodiments, a data set readable by a machine is provided and represents the deconvoluted digital signal data set formed by a signal processing method according to various embodiments described herein. A machine can be, for example, a general purpose computer, a computer specializing in DNA processing, a network computer, or combinations thereof. The machine readable data set can be, for example: data stored in or on a RAM, ROM, CD-ROM, or disk; a packet stored on a network; a machine readable barcode; or a combination thereof.

Other embodiments will be apparent to those skilled in the art from consideration of the present specification and practice of the embodiments disclosed herein. It is intended that the present specification and examples be considered as exemplary only and not limiting.

What is claimed:

1. A signal processing method comprising:
providing a computer system comprising a signal processor and a display;
providing at least one digital signal data set defined on a time axis including at least one amplitude representing a sample containing at least one nucleic acid;
estimating a plurality of local point spread functions for the at least one digital signal data set;
for each estimated local point spread function, comparing the estimated local point spread function to variations of other estimated local point spread functions within a local area;
segmenting the at least one digital signal data set into a plurality of different digital signal data segments based on the variations of the surrounding estimated local point spread functions;
within each respective digital signal data segment, weight-averaging the respective estimated local point spread function to obtain an estimated weight-averaged point spread function within the segment;
adaptively and directly iteratively deconvoluting each of the plurality of different digital signal data segments in a time domain based on the respective estimated weight-averaged point spread function, to form a deconvoluted digital signal data set comprising a plurality of separate deconvoluted digital signal data segments each including at least one deconvoluted amplitude, wherein each of the adaptively and directly iteratively deconvoluting steps comprises performing an iterative deconvolution for the respective digital signal data segment until at least one of (a) a preset number of iterations are executed, or (b) an error criterion is satisfied;
identifying the presence of the at least one nucleic acid based on at least one of the deconvoluted amplitudes; and
generating a graph of signal strength verses time, on the display, showing the presence of the at least one nucleic acid, wherein the signal processor performs the adaptively and directly iteratively deconvoluting.

2. The signal processing method of claim 1, wherein the deconvoluted digital signal data set is represented as a graph of signal strength on a first axis plotted against the time axis, and at least one graphical peak formed by the deconvoluted digital signal data set includes a portion, having an average width that is thinner along the time axis than the width of the same graphical peak if plotted without having been adaptively and directly iteratively deconvoluted.

3. The signal processing method of claim 1, further comprising preprocessing the at least one digital signal data set prior to the estimating a plurality of local point spread functions.

4. The signal processing method of claim 1, further comprising:
performing a round of basecalling of the at least one digital signal data set prior to the estimating a plurality of local point spread functions for the at least one digital signal data set, to form at least one respective first basecalled data set; and
verifying an accuracy of the at least one deconvoluted digital signal data set by comparing the at least one first basecalled data set to the deconvoluted digital signal data set.

5. The signal processing method of claim 1, further comprising normalizing the at least one amplitude of the at least one deconvoluted digital signal data set.

6. The signal processing method of claim 1, wherein the estimating of each local point spread function of the plurality of local point spread functions, for the at least one digital signal data set comprises:
isolating portions of the at least one digital signal data set that represent the presence of nucleic acids in the sample, to form at least a first isolated portion and a second isolated portion; and
estimating separate local point spread functions for each of the first isolated portion and the second isolated portion.

7. The signal processing method of claim 1, wherein the at least one digital signal data set comprises a plurality of digital signal data sets.

8. The signal processing method of claim 1, wherein:
the at least one digital signal data set comprises a plurality of digital signal data sets;
the estimating comprises adaptively estimating a plurality of respective point spread functions for each of the plurality of respective digital signal data sets; and
the iteratively deconvoluting comprises iteratively deconvoluting the plurality of respective digital signal data sets based on the respective estimated point spread functions, to form a respective plurality of deconvoluted digital signal data sets each including at least one deconvoluted amplitude representing the presence of the at least one labeled nucleic acid.

9. The signal processing method of claim 1, wherein each of the adaptively and directly iteratively deconvoluting steps comprises iteratively deconvoluting for a number of iterations, and wherein the number of iterations is preset.

10. The signal processing method of claim 1, wherein each of the adaptively and directly iteratively deconvoluting steps comprises iteratively deconvoluting for a number of iterations, and the number of iterations is determined based on a mean square error (MSE) criteria between adjacent iterations.

11. The signal processing method of claim 1, wherein the digital signal data set includes a plurality of signals representing a sample containing at least adenine, thymine, guanine, and cytosine.

12. The signal processing method of claim 1, wherein the at least one amplitude represents a sample that includes at least one of either mitochondrial DNA or nuclear DNA.

13. A data set readable by a machine representing the deconvoluted digital signal data set formed by the signal processing method of claim 1.

14. The signal processing method of claim 1, wherein the iteratively deconvoluting the at least one digital signal data set comprises computation of a contract mapping function.
